(19) United States
(12) Patent Application Publication
(10) Pub. No.: US 2008/0011842 A1
(43) Pub. Date: Jan. 17, 2008

(54) ASSET MANAGEMENT

(75) Inventors: James A. Curry, Lakewood, CO (US); Theodore G. Arnold, Highlands Ranch, CO (US)

Correspondence Address: FISH & RICHARDSON P.C., P.O. BOX 1022, MINNEAPOLIS, MN, 55440-1022, US

(73) Assignee: ELECTRONIC DATA SYSTEMS CORPORATION, Plano, TX (US)

(21) Appl. No.: 11/777,859

(22) Filed: Jul. 13, 2007

Related U.S. Application Data
(60) Provisional application No. 60/830,825, filed on Jul. 14, 2006.

(51) Int. Cl. G06Q 30/00

(52) U.S. Cl. 235/385; 705/28

(57) ABSTRACT

Systems, processes, and devices may facilitate asset management. In particular systems, processes, and devices may test and analyze inventory tags on objects, such as a company's assets, and track and manage objects. A system may include inventory tags, inventory tag readers, and/or a data storage module. Various types of inventory tags may be positioned on various positions of an object using different types of coupling and tests may be performed. Results from the test(s) may be analyzed and an appropriate type, position, and/or type of coupling for the inventory tag on the object may be determined. Inventory tags may be positioned on one or more objects based on the determined appropriate location and the objects may be tracked and/or managed.

### CLAIM OF PRIORITY

This application claims priority under 35 USC §119(e) to U.S. Patent Provisional Application No. 60/830,825, filed on Jul. 14, 2006, the entire contents of which is hereby incorporated by reference.

### TECHNICAL FIELD

This invention relates to asset management, and more particularly to asset management using inventory tags.

### BACKGROUND

Asset management is an important aspect of business functions. Businesses need to be able to quickly identify and locate assets. Accurately tracking assets facilitates day-to-day functions such as. operations, servicing, replacement, and/or purchasing. Many businesses periodically audit assets to ensure they are being deployed according to business plans and to identify and/or deter theft of assets from the business.

Currently, inventory tags (e.g., Radio Frequency Identification Device (RFID) tags) are used to track and inventory various objects, such as equipment, furniture, computers, shipping containers, and products for sale by a company. However, inventory tags may be difficult to read when poorly positioned, when applied improperly, or when the wrong type of tag is used for an object and without proper inventory tag usage, the ability to manage and/or inventory objects is greatly reduced.

### SUMMARY

Systems and processes for inventory tag analysis may include one or more inventory tags, inventory tag readers, user computers, field instruments, data storage modules, data storage management modules, and/or data presentation modules. One or more inventory tags, of the same or different type, may be positioned on at least one position on one or more objects. Tests may be performed on the inventory tags. In some implementations, tests may include identifying the position of an inventory tag, identifying the type of inventory tag, identifying how the tag is coupled to an object, determining a maximum distance from which the inventory tag can be read by an inventory tag reader, and/or reading the inventory tag while the object performs various functions.

A data storage module may include data segments associated with testing one or more positions of at least one inventory tag on an object. In some implementations, data segments may be associated with testing two or more positions of at least one inventory tag on an object, testing one or more positions of at least two inventory tags on an object, and/or testing one or more positions of at least one inventory tag on each of a plurality of objects. A data segment may include an object identity, data regarding an inventory tag, and/or may be for test result data from testing inventory tags. Test result data may be stored in a data portion during or after performing tests. Data portions may also include testing data including descriptions of tests to be performed and/or images of inventory tags at a position on an object.

A data presentation module may present data segments and/or data portions in the data storage module. A data presentation module may format at least a portion of data segments into a user-presentable format. For example, the data presentation module may visually display or present as printed media data segments and/or data portions.

A field instrument may be coupled to the data storage module. The field instrument may include a communication interface, a display, and/or an input device. The communication interface may allow communication with the data storage module and/or may retrieve data segments from the data storage module. For example, the communication interface may transmit entered data into data portions to the data storage module. A display may visually present data retrieved segments and an input device may allow a user to enter test result data into a data portion. In some implementations, the field instrument may include a personal digital assistant or may be coupled to an inventory tag reader.

In some implementations, the data storage module may be stored and data portions in the data storage module may be retrieved, such as the test result data from testing inventory tags. Data portions in the data storage module may be retrieved based on user-specified criteria and/or visually displayed. Retrieved data portion may be transmitted to a field instrument. Test result data may be received from a field instrument and stored in a data portion of a data segment of the data storage module. Data portions, such as data portions including test result data, may be sorted. An appropriate position for an inventory tag on an object may be identified at least partially based on the retrieved data portions. In some implementations, a report may be generated, such as a report including deployment instructions for an inventory tag at least partially based on an identified appropriate position.

Various implementations may include one or more features. For example, systems and processes provide increased tracking efficiency since an appropriate position and/or type for an inventory tag on an object may be identified prior to positioning inventory tags on several objects allowing easier identification of the objects. Another aspect of the systems and processes may include increased cost-effectiveness of the tracking system since various inventory tags may be effectively tested prior to positioning inventory tags on several objects. For instance, the value of an increased range or reduced interference of a more expensive inventory tag may be evaluated prior to positioning the inventory tag on several objects. As an additional example, systems may facilitate determining the feasibility of tracking and/or inventorying specific objects, since tests are performed on the object prior to positioning inventory tags on several objects.

The details of one or more implementations are set forth in the accompanying drawings and the description below. Other features will be apparent from the description and drawings, and from the claims.

### DESCRIPTION OF DRAWINGS

FIG. 1 is a flowchart illustrating one example of a process for analyzing one or more inventory tags for an object.

FIG. 2 is a flowchart illustrating an example of a process for testing an inventory tag on an object.

FIG. 3 is a block diagram illustrating an inventory tag analysis system.

FIG. 4 illustrates one example of a user interface for presenting information in asset management data storage module.

FIG. 5 illustrates one example of a user interface where tests may be reviewed and test results may be reviewed and entered.

FIG. 6 is a flowchart illustrating an example process for configuring a data storage module for asset management.

FIG. 7 is a representation of an asset management system.

Like reference symbols in the various drawings indicate like elements.

### DETAILED DESCRIPTION

In various implementations systems and processes may facilitate asset management for a business enterprise. An asset management system may include one or more inventory tags, one or more inventory tag readers, one or more data storage modules, and/or a user interface. Prior to coupling inventory tags to objects, different types of inventory tags, positions on an object, orientations or an audit, and/or types of coupling may be tested to determine appropriate type, position, orientation, and/or coupling of the inventory tags to the objects. A data storage module may store test data, test result data, and/or other information from before, during, or after testing. The data storage module may also store locations of objects and/or object data after inventory tags have been coupled to the objects. The data storage module storing test data and the data storage module storing locations of objects after testing may be the same or different. The data storage modules may be on or coupled to a computer, whether directly or indirectly.

Inventory tags and inventory tag readers may be used for asset management. In some implementations, inventory tags may include RFID and inventory readers may include RFID readers. Other appropriate types of tags and readers may also be used.

Inventory tags may be active, semi-passive, or passive. Inventory tags may be coupled to objects to identify the objects. For example, inventory tags may be coupled to an object to be tracked and/or inventoried, such as items in a manufacturer's inventory or assets; products produced by a company; electronic or other equipment used by a company; high value items; or other objects, such as boxes or chairs.

To track and/or inventory objects, an inventory tag may be coupled to the object. Several factors may cause interference with an inventory tag such as, the position of the inventory tag, the type of inventory tag used, the type of object, and/or the proximity of the object to other objects that may cause interference. However, the position, coupling, and/or type of an inventory tag may typically be adjusted to reduce interference and facilitate object tracking. Therefore, possible positions, couplings, and/or types of inventory tags may be tested prior to installing the inventory tags on a large number of the objects to be tracked and/or inventoried. Testing the inventory tags may increase the effectiveness of the inventory tags and facilitate uniform placement of inventory tags on similar objects, thus possibly increasing ease of use and performance.

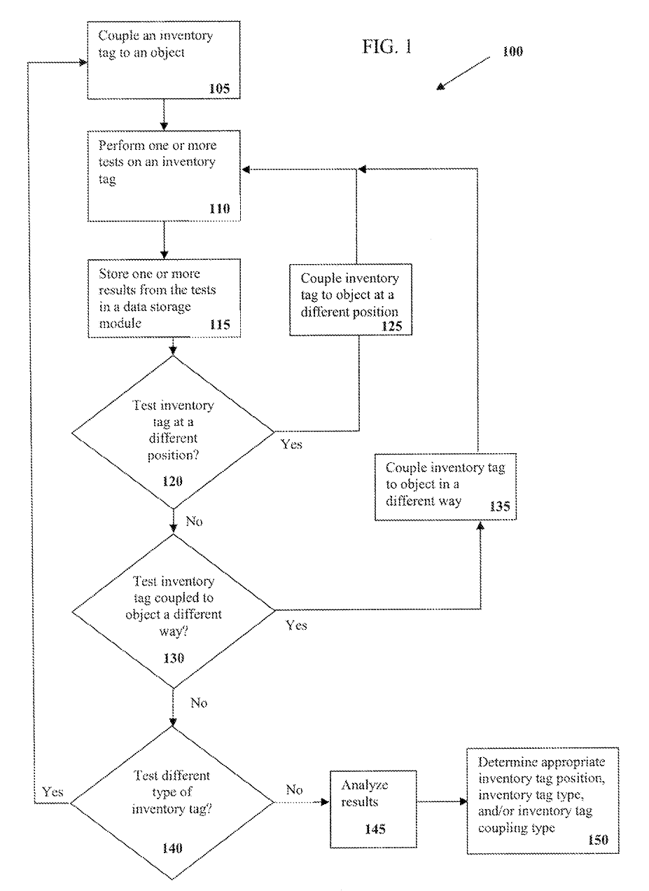

FIG. 1 illustrates a process 100 for inventory tag analysis for an object. The process begins with coupling an inventory tag to an object (operation 105). An inventory tag may be attached, affixed, bonded, taped, sealed, secured, adhered, or otherwise coupled to an object at a position. A position on an object may refer to a location on the object and/or an orientation with respect to the object. An inventory tag may also be coupled to an object via an intermediary. An intermediary may raise the inventory tag off the surface of an object and/or be designed of a material to decrease interference with readings. Raising an inventory tag off a surface of an object may decrease interference with reading an inventory tag.

In some implementations, the selection of an inventory tag may depend on the identity of the object. For example, metal objects may interfere with reading passive tags, so an active inventory tag that transmits a signal may have less interference. In addition, some objects, such as electronic objects, may transmit signals that interfere with the recognition of an inventory tag, so a suitable type of inventory tag for the object may be selected that reduces interference. Since different types of inventory tags experience different interference and/or levels of interference, different types of inventory tags may be coupled to on the object to determine which tag can be read with the least interference or a predetermined allowable level of interference. For example, it may be appropriate to use a first type of tag that may have more interference than a second tag when the first tag is more cost-effective, allows for easier coupling, and/or reading, and has less than a predetermined allowable level of interference.

Inventory tags may also be coupled to the object at more than one position. Inventory tags may be read more easily by a tag reader at certain orientations, due to the type of inventory tag and/or the nature of the object (e.g., a tag reader may experience interference when reading a tag through the components of a computer system rather than reading a tag directly). Thus, inventory tags may be positioned at a variety of locations and/or orientations to determine the appropriate position of the tag.

After being coupled to the object, the inventory tag is tested (operation 110). Any test that facilitates determining the performance of the inventory tag (e.g., read distance, successful read, failed read, weak signal, interference in reading tag from proximate objects) may be performed. In certain implementations, more than one test may be performed on an inventory tag (e.g., readings may be obtained while the object is on, the object is off, the object is behind a closed door, etc.).

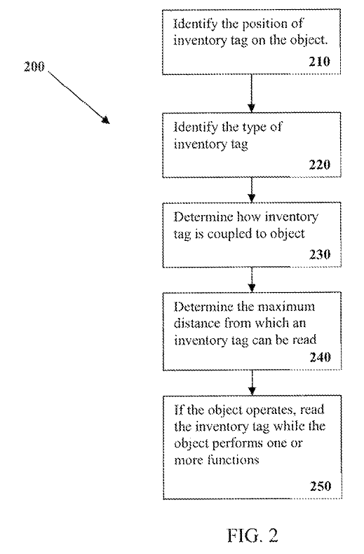

FIG. 2 illustrates an example of a process 200 for testing an inventory tag on an object. The position of an inventory tag may be identified (operation 210). As explained previously, the position of an inventory tag may affect its performance, so properly identifying the position may assist in proper testing. In some implementations, one or more images of the inventory tag on the object may also be captured. Capturing at least one image of the position of the inventory tag on the object may facilitate placement of the inventory tags on the object and/or similar objects after a determination is made of the appropriate position, inventory tag type, and/or type of coupling for the object.

The type (e.g., active or passive tag) of inventory tag may also be identified (operation 220). The coupling of the tag to the object may additionally be determined (operation 230). Images of the inventory tag on the object may also facilitate replication of the coupling of the inventory tag (e.g., position, type, etc.) to the object.

The maximum distance from which the inventory tag can be read by a tag reader may be determined (operation 240). If the object operates (e.g., is electronic, has mechanical components, or receives or transmits data), then the tag may be read while the object performs various functions (e.g., while a processor is running, while the object stores data on a memory, while the machine is operating, while the object transmits data to a remote memory) (operation 250).

Although process 200 is described in a specific order, the operations can be performed in a variety of orders, and some operations may be added or deleted. For example, operations 210-250 may be performed in almost any order. As another example, the coupling of the tag to the object may not be determined. For example, because a specific type of coupling may be associated with a specific inventory tag, the coupling does not need to be determined. In addition, other tests may be performed such as reading an inventory tag with different types of inventory tag readers or reading the inventory tag through closed and/or open doors. Furthermore, the maximum distance from which an inventory tag may be read (operation 240) may be performed after an inventory tag is read while the object performs various functions (operation 250). As another example, the tag may not be read while the object performs various functions.

Referring again to process 100, the results of the tests may be stored in a data storage module (operation 115). The data storage module may be a memory organization such as a database. The data storage module may reside on a remote system (e.g., PC, server, etc.) and/or a user's computer (e.g., PC, laptop, PDA) simultaneously. The data storage module may be accessed via one or more network protocols (e.g., TCP/IP, Ethernet, or Bluetooth) from the computer. Thus the data storage module, or a portion of it, may be readily taken into the field so that field personnel can review test procedures and/or data and/or enter test results.

The test results may be input into the data storage module. For example, the data storage module may at least reside on a remote server and/or a portion may reside on a user's computer (e.g., PDA). The test results may be read and directly recorded into the data storage module by a computer such as a field instrument that includes an inventory tag reader and is coupled to the data storage module. The test result data, including results of testing, images, and/or other data obtained during or after testing, may be entered by a user into the data storage module during and/or after tests are performed.

After testing has been performed on an inventory tag, a determination may be made regarding whether the inventory tag should be tested at a different position on the object (operation 120). An inventory tag may be tested at different positions on an object to determine an appropriate position for the inventory tag (e.g., inventory tags may experience more or less interference at some positions). If an inventory tag should be repositioned, the inventory tag may be removed and coupled to a different position (operation 125), or a new inventory tag of the same type may be coupled to a different position on the object. Test(s) may then be performed on the newly positioned inventory tag (operation 110).

If the inventory tag should not be repositioned (e.g., appropriate positions on the object have been tested or other positions would be inaccessible), a determination may be made regarding whether the inventory tag should be coupled to the object in a different way (operation 130). For example, an inventory tag may be directly affixed to a surface of a device. As another example, an inventory tag may be affixed to an intermediary which is affixed to a surface of a device. In some implementations, use of an intermediary and/or an appropriate coupling type (e.g., glue, bonded, affixed, magnetically coupled) between the inventory tag and the object may affect performance of the inventory tag. If it is determined that an inventory tag should be coupled differently to the object, the inventory tag may be removed and coupled to the object in a different way and/or a new inventory tag may be coupled to the object using a different type of coupling (operation 135). After the inventory tag has been coupled in a different way to the object, tests may be performed on the inventory tag (operation 110).

If a determination is made that the inventory tag should not be coupled differently to an object (e.g., appropriate types of coupling have been tested, other coupling types are not feasible, or other types of coupling are not available on the selected type of inventory tag or object), a determination may be made as to whether other types of inventory tags should be tested (operation 140). For example, active, passive, and semi-passive inventory tags may be tested to determine what type of inventory tag would be appropriate. Furthermore, other types of inventory tags (e.g., RFID, optical, etc.) may be tested. If a determination is made that other types of inventory tags that should be tested have not been tested, another type of inventory tag may be coupled to the object (operation 105) and test(s) may be performed on the inventory tag (operation 110).

If other types of tags do not need to be tested, the results may be analyzed (operation 145). In some implementations, after testing has been completed on one or more of the inventory tags, the test result data may be transmitted and/or replicated on a data storage module stored of a remote system. For example, after tests have been completed, test result data may be transmitted to the data storage module of a remote system. As another example, test result data may be transmitted to the data storage module after one test has been performed on an inventory tag.

Data stored in the data storage module may be analyzed by sorting and/or querying data segments and/or data portions. A data segment may be data associated with testing an inventory tag on an object. A data portion may be a portion of the data segment. For example, a data storage management module may retrieve one or more data segments from the data storage module. The results may be analyzed (e.g., sorted or queried) according to various analysis criteria such as business rules, industry rules, government rules, past experience, or cost effectiveness. Examples of analysis criteria include required minimum distance at which inventory tag may be read, capability to read tag while the object or an object near by performs various specified functions (e.g., while the phone rings or while the hard drive is spinning), percentage of failed reads for the inventory tag less than a specified percentage, ease of access to the inventory tag and/or for combinations thereof. For example, analysis criteria may include minimum criteria for an inventory tag to satisfy, such as a minimum distance from which a tag may be read and readability of the tag while an object performs a specific operation (e.g., while a computer is on). The analysis criteria may be user-specified criteria and/or included in the data management module (e.g., the data management module may include analysis criteria with which the data portions may be analyzed).

The test result data in the data storage module may be analyzed according to analysis criteria to facilitate determination of appropriate type of coupling between an inventory tag and an object, appropriate type of inventory tag for an object, and/or appropriate position of an inventory tag on an object (operation 150). For example, a position of the inventory tag may be selected that is easily accessible to a person positioning inventory tags on objects and meets predetermined criteria. In some implementations, the lowest cost type of inventory tag may be selected that meets predetermined criteria such as length of operational life and read distance. For example, an appropriate position and/or type may be the lowest costing inventory tag that meets analysis criteria of ability to be read ten feet away and/or can be read while a computer is on.

The analysis may be performed in an automated manner. For example, the analysis may be automatically performed based on predefined criteria. Additionally, a user may select one or more criteria from the analysis criteria included in the data storage management module (e.g., from a drop down menu) according to which the test results will be analyzed. The user may then determine the appropriate type of coupling between an inventory tag and an object, appropriate type of inventory tag, and/or appropriate position of an inventory tag on an object based at least partially on the test results retrieved using the selected analysis criteria.

In some implementations, data portions of the data storage module, such as test results, may be presented using a data presentation device. The data presentation module may visually present (e.g., in a text or graphical interface) the data portions and/or present the data as printed media. A report may be generated that includes the appropriate type of coupling between an inventory tag and an object, appropriate type of inventory tag for an object, and/or appropriate position of an inventory tag on an object.

Although process 100 is described in a specific order, the operations can be performed in other orders, and some operations may be added or deleted. Operations 120, 130, and 140 may, for example, be performed in any order. As another example, one or more of operations 120, 130, and 140 may be deleted. In some implementations, an image may be obtained of the inventory tag on the object and entered into the data storage module. As further example, a user may record comments regarding the testing of the inventory tag (e.g., tag was difficult to position or tag broke during placement) and convey the comments to the data storage module.

In one aspect, after an appropriate position and/or type of inventory tag and/or coupling is determined, inventory tags may be positioned on one or more similar objects. A deployment report may be generated to facilitate the positioning of inventory tags or objects. The deployment reports may include the captured images of the position of the tag on a similar object, coupling type, and/or type of tag. For example, the image may illustrate the appropriate position for an inventory tag and/or how the inventory tag is to be coupled to an object (e.g., directly or indirectly, such as by using an intermediary). Utilizing the image of the inventory tag may facilitate implementation of an asset tracking system and/or increase the consistency of inventory tag positioning, and thus increase the overall effectiveness of the asset management system.

In particular implementations, process 100, or a similar process, may be performed on more than one object. For example, a location at which inventory tags may be used for asset management purposes may include a plurality of object types. Process 100 may be performed for each object in the location and/or for each type of object in the location. For example, when objects are similar (e.g., the same types of PC, the same type of phone, similar types of bookcases) and/or similarly situated (e.g., orientation in the room, proximity to other objects, etc.) process 100 may be performed on one of the similarly situated objects.

After compiling test results data for one or more of the objects (e.g., tag performance relative to the tag type, tag position, and/or tag coupling), the test result data may be analyzed. For example, the data may be analyze to determine if a particular tag and/or coupling technique may be used for objects, or similar objects, at the location. As another example, the test result data could be analyzed to determine if the location suffers from substantial interference. This could, for example, be determined from a large percentage of tags failing despite being coupled to different types of devices with different coupling and positions. As another example, the data may be analyzed to determine if particular types of tags that can be read with the same reader may be used for objects, or similar objects, at the location. The data could, of course, be analyzed on an object-by-object basis to determine the appropriate tag type, tag position, and/or tag coupling.

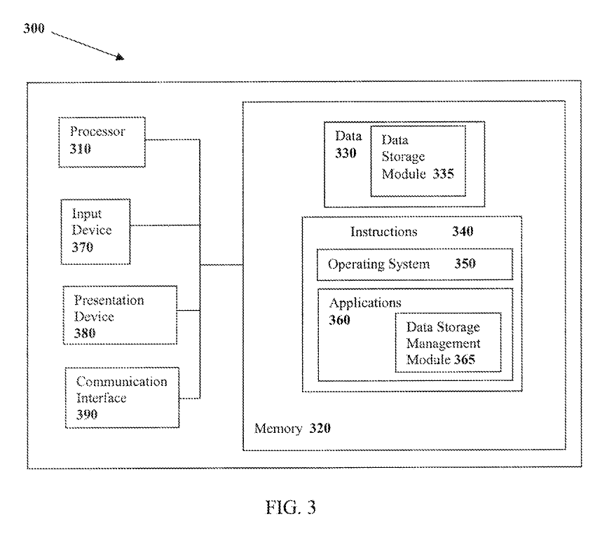

FIG. 3 illustrates a system 300 for an asset management. Although the system 300 is described below in terms of a user's computer, similar computer systems may be used for other computer systems in the asset management system such as computer systems remote from the user's computer. System 300 may be any computer system in the asset management, such as the computer system that allows entry of test data prior to inventory tag testing, entry of test result data into the data storage module, transmission and/or receipt of the data storage module or portions thereof, generation of the data storage module during or after deployment of the inventory tags on objects at a location, and/or retrieval of portions of the data storage module.

System 300 may be a PC, a laptop, a personal digital assistant (PDA), a smart phone, or a field instrument. A field instrument may be portable, small in size, lightweight, and/or capable of communicating with remote systems to allow a user to carry the device in the field. A field instrument may be a combination personal digital assistant and inventory tag reader. A field instrument may be coupled to or include a digital camera or other device capable of recording images. Incorporating a camera with the field instrument may facilitate capturing images of positions of inventory tags on objects during testing. Incorporating items such as an inventory tag reader or a camera with the field instrument may facilitate testing of inventory tags. In some implementations, a field instrument may be coupled to an inventory tag reader using protocols such as Bluetooth®, TCP/IP, Wi-Fi, FireWire, IR, or USB. The field instrument may improve asset tracking and management by reducing the amount of information a user must manually enter into data portions of the data storage module, and thus human error.

System 300 includes a processor 310 and a memory 320. Processor 310 may be a programmable logic device, a microprocessor, or any other appropriate device for manipulating information in a logical manner. Memory 320 may include volatile memory (e.g., Registers or RAM), nonvolatile memory (e.g., ROM or disk drives), or any other appropriate information storage device. Memory 320 may includes data 330, such as data storage module 335, and instructions 340.

A data storage module may be a collection of information such as in a spreadsheet (e.g., Microsoft® Excel or Lotus®) and/or in a database (e.g., Microsoft® Access, SQL, or other appropriate database). A data storage module may be a flat database, a relational database, or a hierarchical database. In some implementations, the data storage module 335 on the system 300 may be at least a portion, a copy of at least a portion, and/or a replication of at least a portion of the data storage module stored in a remote system.

A data storage module may include data segments associated with testing one or more positions of at least one inventory tag on an object. In some implementations, data segments may be associated with testing two or more positions of at least one inventory tag on an object, testing one or more positions of at least two inventory tags on an object, and/or testing one or more positions of at least one inventory tag on each of a number of objects. Portions of the data segments may be associated. A data segment may include an identity of an object, inventory tag data, type of coupling between the inventory tag and the object, test description (e.g., title of test and/or how to perform a test) and/or test result data from testing inventory tags.

Each item of data may be a portion of the data segment. Although a data segment may be collection of data portions, the portions of a data segment do not have to be physically stored next to each other in a memory. The portions may, for example, be associated by pointers or linked lists. The data portions of a data segment therefore may just be logically related to the segment. Test result data may be stored in a data portion during and/or after performing tests. Data portions may also include testing data including descriptions of tests to be performed and/or images of inventory tags at a position on an object.

Instructions 340 may include an operating system 350 (e.g., UNIX, Linux, or Windows) and applications 360 such as a data storage management module 365 (e.g., Microsoft® Access or Oracle® Database).

Computer 300 may include an input device 370 (e.g., a keyboard or a touch screen), a presentation device 380, and/or a communication interface 390. Test results may be entered into the data storage module 335 via the input device 370. Presentation device 380 may format data or at least a portion of the data storage module 335 into a user-presentable format (e.g., visually display or printed media). For example, presentation device 380 may include a monitor and/or a printer. Access to the data storage module of the asset management system may be facilitated via a user-presentable format (e.g., a user interface on a website or a user interface on a field instrument).

Communication interface 390 (e.g., a modem, a network interface card, or any other appropriate interface between computer systems) may communicate with data storage module 335 and/or with systems remote to the computer 300. Communication interface 390 may communicate with remote systems via network protocols. For example, the user may access remote computer systems via the Internet or Bluetooth®. Communication interface 390 may verify an identity of a user prior to allowing access to data storage module 335. In some implementations, communication interface 390 may access a remote data storage module 335 to replicate at least a portion on a memory 320 of computer 300. The communication interface 390 may also send a modified data storage module 335 or modifications to data storage module.

In some implementations, a system 300 may include or be coupled to an inventory tag reader. Coupling to an inventory tag reader may allow direct entry of test results into the data storage module 335. Allowing direct entry of test results into the data storage module 335 may reduce the chance for human error by reducing the amount of data a user must enter manually. Reducing error in recording test results may facilitate determination of the appropriate position for an inventory tag on an object.

When a user accesses the data storage module, the user may be able to specify (e.g., enter) information specific to the task the user is performing so that the appropriate data segment or data portion is accessed. Data may be directly transferred to the data storage module via a computer and/or field instrument.

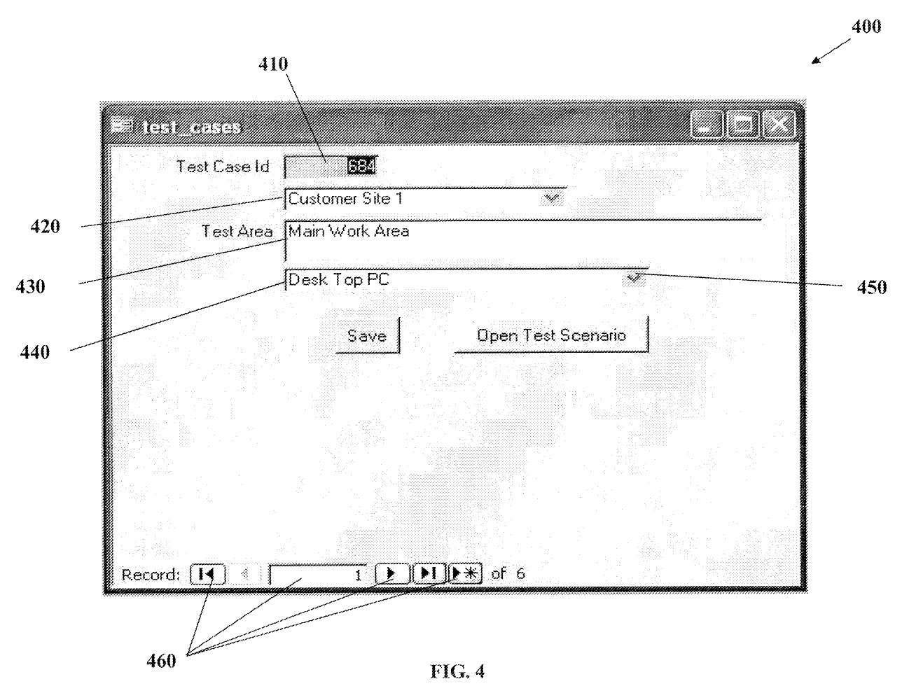

FIG. 4 illustrates an example of a user interface 400 for the data storage module. User interface 400 may, for example, be a pop-up screen. Through the user interface 400, a user may access one or more data segments or create one or more data segments (e.g., records) or data portions (e.g., fields) in the data storage module associated with the task. For example, a Company A may desire tracking of desktop computers in a main work area of the company's site. Prior to installing inventory tags on all of the desktop computers, the user may utilize the asset management system. The user may access the user interface 400 of the tag analysis system to gain access to the data segments in the data storage module associated with the task of (determining where to position) inventory tags on desktop computers for Company A. The user may specify values in various data portions (e.g., fields in a database) in the user interface 400, such as an identification number 410, the name of the company's facility 420, the site location in the facility 430, and/or the identity of the object to be tracked 440. The user may be able to specify the identification number 410, the name of the company's facility 420, the site location in the facility 430, and/or the identity of the object to be tagged 440 by inputting the data or selecting it (e.g., from a drop down menu 450). One or more data portions (e.g., fields in a database) of the user interface 400 may be automatically generated when values are specified or selected for other data portions in the user interface. The user interface 400 may include buttons or links 460 that will allow the user to access data in a data storage module associated with the values specified in the data portions of the user interface and/or generate reports based on the data segments and data portions in the data storage module associated with the values specified in the data portions of the user interface. A user may be able to browse various tasks by selecting links or buttons 460 on the user interface 400.

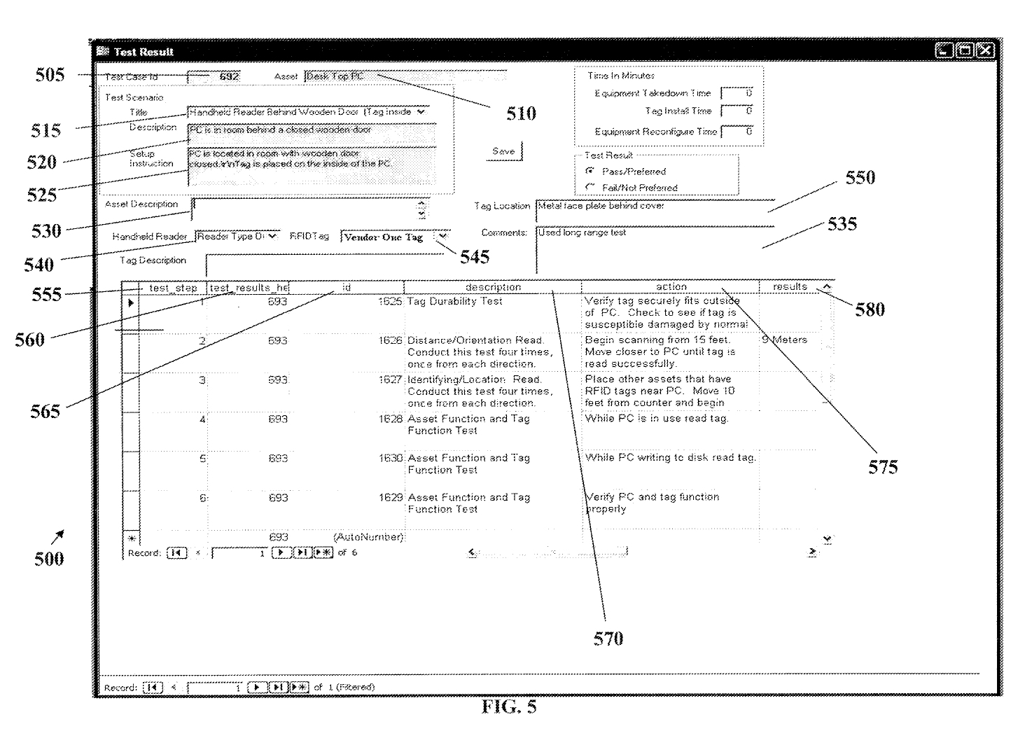

After specifying values in data portions of the user interface 400, the data segments associated with the data portions (e.g., values in fields of a database) may be displayed in a user interface 500, as illustrated in FIG. 5. User interface 500 may be built (e.g., data may be specified) to be provided to a person who performs tests on inventory tags, to determine tests associated with inventory tag testing, and/or to analyze inventory tag testing results.

User interface 500 may include the identification number of the task 505, the name of the company's facility, the site location in the facility, and/or the identity of the object to be tracked 510. The user interface 500 may include a data portion that identifies the name of a test (e.g., handheld reader behind wooden door) 515, a description of the test 520 (e.g., on a PC behind a wooden door), and/or instructions for test setup 525. The user interface 500 may include data such as a description of the object 530, a description of the tag position 550 on the object, and/or a data portion (e.g., a blank field) for specifying a user's comments 535. The user interface may allow a user to record the identities of the inventory tag reader 540 and/or inventory tag 545 used in tests. The name of the test, a description of the location of the test object, the instructions for test setup, a description of the object, and/or the identities of the inventory tag reader 540 and/or the inventory tag 545 may be provided as pre-populated data in user interface 500, which may facilitate performing inventory tag testing, analyzing inventory tag testing results, and/or positioning inventory tags on assets after testing.

User interface 500 may include data portions associated with the tests and the results of the tests 555, 560, 565, 570, 575, and 580. Some of the data portions associated with the tests may be specified (e.g., entered) or pre-populated prior to performing the tests. The pre-populated fields may be automatically populated based on the identity of the inventory tag, the identity or nature of the object, and/or the task to be performed. For example, fields associated with the order in which tests are performed 555, test result header identification number 560, an identification number associated with the test 565, and descriptions of the test, such as a title 570 and/or how to perform the test 575, may be specified or pre-populated prior to performing the tests on the inventory tags. During or after the performance of tests, the result data obtained during testing may be entered in one or more test result data portions 580 of the data storage module.

The user may be able to query or sort the data portions or data segments associated with the tests and test result data 555, 560, 565, 570, 575, and 580. Querying or sorting the data segments or data portions associated with the tests and the test result data may facilitate analysis of the results and thus facilitate determination of the appropriate position for an inventory tag, appropriate type of inventory tag, and/or appropriate type of coupling between inventory tag and object. For example, data portions may be queried based on analysis criteria (e.g., included in a data storage management module or user-specified) and the data portions retrieved according to the analysis criteria may also be sorted and/or vice versa. For example, data portions may be analyzed by querying the data portions based on the inventory tags that failed. The retrieved data portions may then be analyzed by sorting by minimum read distance to determine if the failures were due to the distance from which inventory tags were read being too large.

The relationship and order of data portions in FIG. 5 are for illustrative purposes only. Data portions for a segment may not be directly associated with each other and/or may be displayed in different orders.

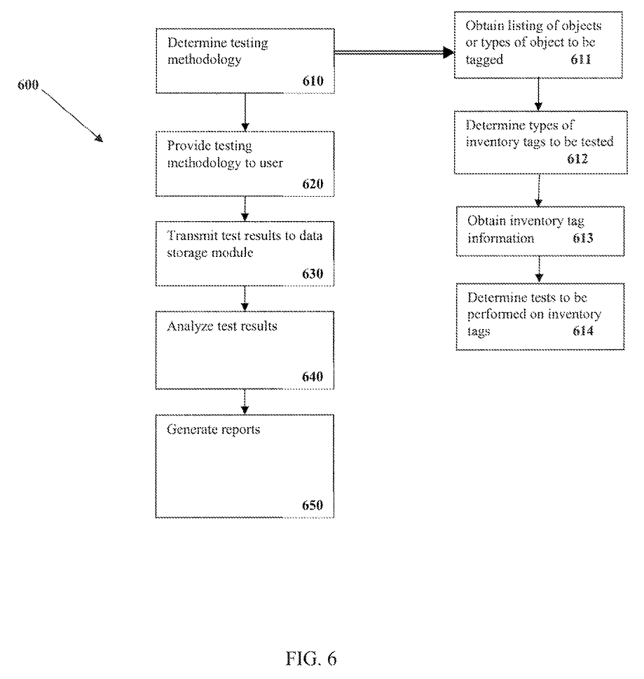

As mentioned previously, in some implementations, portions of a data storage module may be configured prior to testing. FIG. 6 illustrates a process 600 for configuring a data storage module for testing inventory tags on objects. Prior to testing an inventory tag on an object, the testing methodology may be determined (operation 610). Operations 611 to 614 illustrate an exemplary process for determining a testing methodology. A listing of assets to be tagged and/or types of assets to be tagged may be obtained (operation 611). For example, an area that contains assets that may be tagged may be surveyed and assets may be identified. A data segment of the data storage module may correspond to the area to be tagged and/or the types of assets to be tagged. The identity of the assets or types of assets may be stored in the data storage module (e.g., as a data portion).

Types of inventory tags to be tested for each asset may be determined and/or stored in the data storage module (operation 612). Inventory tag data (e.g., type of inventory tag, positions at which the inventory tag should be coupled, type of inventory tag reader to be used with an inventory tag, operational life of inventory tag, theoretical distance inventory tag may be read from, or other information about the inventory tag) may be determined (operation 613) and/or stored in the data storage module. In some implementations, a data storage module may include at least a portion of the inventory tag data for each inventory tag selected, such as operational life or theoretical distance from which inventory tag may be read.

A listing and/or description of tests to be performed on each inventory tag positioned on an object may be determined (operation 614) and/or stored in the data storage module. For example, the data storage module may include a listing and/or description of tests performed based on business, industry and/or governmental rules and/or experience. A listing of tests to be performed on each inventory tag may be determined based at least partially on the listing stored in the data storage module (e.g., a listing may be determined based on tests previously performed on similar inventory tags and/or in similar positions on an object or in a position). A description of tests may facilitate inventory tag testing and uniformity of testing since descriptions encourage users to perform a test the in a consistent manner. The data storage module may include a portion of data segments for the test results that are coupled to the listing of tests to be performed. The data for the data portion of the data segments for the test results may be specified as a user performs the determined tests.

The testing methodology may be provided to a user performing the testing of inventory tags on objects (operation 620). For example, a user performing the testing of the inventory tags on the objects may retrieve one or more data segments or portions thereof associated with the testing to which the user is assigned. A user may, for example, retrieve the data segments from the data storage module via a computer (e.g., a field instrument). The data segments may facilitate testing and increase uniformity in recording results. For example, the empty data portions associated with the test results may only accept entries in a specified format or a user may select a test result from a drop down menu of options.

Once a user has completed the test(s), the test results and/or the data portions retrieved from the data storage module may be conveyed (e.g., transmitted) to the data storage module (operation 630). For example, test results may be transmitted to and/or stored in the data storage module periodically, when a test is complete, or when a set of tests are complete. In some implementations, a computer, such as a field instrument, may include at least a portion of the data storage module or a replication of at least a portion of the data storage module. Test results may be stored in the data storage module, or portion of the data storage module, or replication thereof stored in the computer. Test result data may update a replication of a data storage module (e.g., stored in a remote system). For example, the data storage module may update data segments, or portions of data segments, based on the transmitted data. A user may then access the data segments in the data storage module to analyze the test results (operation 640).

In various implementations, reports may be generated based on the results of analysis criteria and/or determined appropriate position, tag type, and/or coupling type for inventory tags (operation 650). A report may include appropriate types of inventory tags and/or appropriate type of coupling between inventory tag and object. A report may include information about the inventory tag selected (e.g., type of reader required, operating lifetime of inventory tag, or repair instructions). For example, a report may include deployment instructions for at least one of the inventory tags based at least partially on the identified appropriate position. Deployment instructions may include images of the inventory tag on the object to facilitate placement of inventory tags, identities and/or number of objects to be tagged, position of objects to be tagged, type of inventory tag to use, type of inventory tag reader required, and/or other information that may facilitate positioning inventory tags on objects. Reports may be presented visually, printed, or otherwise provided.

In various implementations, after the appropriate position for an inventory tag for an object, appropriate type of inventory tag, and/or appropriate type of coupling between an inventory tag and an object has been determined, an inventory tag may be coupled to an asset based on the deployment instructions. The data storage module may store object data about an object with an inventory tag such as object location, last repair, operational lifetime left, price of object, replacement date of object, whether the object is in use or out of commission, and/or other information that may facilitate tracking and/or management of objects such as the assets of a company. For example, the position of the inventory tag, the location of object (e.g., office 3, warehouse 4, etc.), the type of object, a picture of the inventory tag on the object, and/or last reading date may be stored in the data storage module. The data storage module may be the same data storage module as the data storage module in which inventory test and test result data is stored or a different data storage module. The portions of the data storage module may be extracted from the data storage module in which inventory test and test result data is stored. The data stored in the data storage module may facilitate asset tracking and management.

Some companies may update the object data in the data storage module by reading inventory tags for the objects periodically. For example, a company may send users to a warehouse to inventory all assets biannually to update the object data in the data storage module. A user may read the inventory tags on assets in the warehouse to identify the asset and/or update a location of an asset.

In some implementations, a location tag may be positioned in or near a location (e.g., an office, a building, a warehouse, or a cubicle) where objects reside. During a companies day-to-day operations, assets may move from one location to another and/or be removed or added to storage (e.g., placed in or out of commission). Asset management may be facilitated by identifying changes in asset location and/or maintaining accurate asset count and location information. In addition, service and/or updates on assets (e.g., computers) may be facilitated by maintaining an accurate asset count and location. In certain implementations, a third party provider who provides and/or maintains assets such as computers or machinery to a company may be more able to assess the company's needs and/or track assets within the company. For example, if a third party provider keeps five extra computers in a storage facility at the company's headquarters but only charges for computers in use, accurate assessment of computers in use rather than in storage may increase profit and/or billing accuracy for the third party provider.

A location tag may be the same type or a similar type of tag as an inventory tag (e.g., RFID tag). A location tag may be read by the same reader as the inventory tag (e.g., inventory tag reader or field instrument). A location tag may facilitate asset management for a company. For example, rather than requiring a user to enter or select a location of an object being read, a user may read the location tag with a reader. Since each user testing inventory tags or tracking assets may enter a location differently (e.g., a location may be entered as Office 537-A, Office 537A, 537A, A537, or O 537A), uniformity in data entered may be increased by reading tags rather than entering data. Increasing uniformity may decrease operational costs since a reviewer may not be needed to review and modify data entered by users. The location tag may be read before or after the inventory tag on an object is read.

A location and/or object data associated with the inventory tag on the object may be stored in the data storage module. The data storage module may be coupled to a computer such as a field instrument comprising a memory and a processor. The field instrument may be, for example, a laptop, a personal digital assistant (PDA), or a smart phone. The field instrument may be coupled to an inventory tag reader. In some implementations, the field instrument may be an inventory tag reader coupled to a processor capable of receiving readings from the inventory tag reader and transmitting the readings to a remote system (e.g., a system coupled to a data storage module). The field instrument may be the same or similar to the computer used during testing of inventory tags, as previously described. The field instrument may be capable of receiving and/or transmitting data to the system via one or more network protocols (e.g., Bluetooth, TCP/IP, Ethernet, or Wi-Fi. In certain implementations, the field instrument may be directly coupled to the remote system and data may be transferred from the field instrument to the remote system and/or vice versa.

One feature of utilizing the field instrument for tracking objects may be the ability to quickly identify misplaced inventory. Often, assets are moved from location to location as needs change for a company. However, this may cause problems with asset management since the asset may not be in an expected location. For example, a user auditing inventory for a company may scan a location tag for an asset and/or an inventory tag and determine whether the asset is in the appropriate location. A user may scan a location tag to determine all assets that should be in the location and/or type in a serial number for an asset to locate the asset. Immediate access to appropriate locations for assets may improve recognition of changes to assets and thus improve asset management. Use of inventory tags and location tags may further facilitate asset tracking since tags may be read without substantially hindering ordinary business for a company (e.g., employees may continue to work while the tags are read).

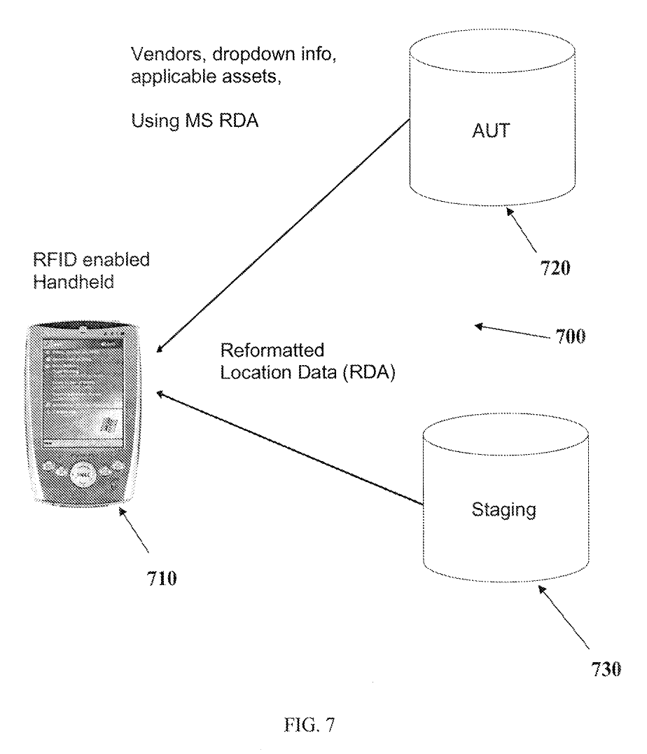

FIG. 7 illustrates a representation of an asset management system 700. System 700 includes a field instrument 710 that may be coupled to two or more data storage modules, such as databases. A first data storage module 720 may store object data (e.g., objects, locations, service history) and a second data storage module 730 may manipulate the data in the first database. Field instrument 710 may be coupled to the first data storage module 720 and/or the second data storage module 730. Object data may be retrieved from the first data storage module 720 and conveyed to the second data storage module 730. Data may be manipulated using the second data storage module 730 such that the field instrument 710 can read, modify, and/or delete the data (e.g., the data may be reformatted to a data type compatible with the field instrument). The data may be sent to the field instrument 710 from the second data storage module 730. A user may inventory assets and record changes and/or verifications of locations using the field instrument 710. For example, the user may walk through an assigned area for inventorying and read inventory tags and/or location tags using a tag reader and/or a field instrument 710 coupled to a tag reader. Data from the field instrument 710 may be transferred to the second data storage module 730. Second data storage module 730 may manipulate the data transferred into a format compatible with the first data storage module 720. Thus, the object data may be updated. Although the above example, describes the use of two data storage modules, one data storage module or more than two data storage modules may be utilized. In some implementations, data may not need to be manipulated to a compatible format for the field instrument.

In some implementations, the data transmitted among computers in the asset management system (e.g., field instruments, laptops, PCs, or other computer systems) may be encrypted or otherwise secured. For example, data may be transmitted using cryptographic protocols such as DES, Triple-DES, AES SSL, or TLS. Data may be transmitted via a secure link such as through a virtual private network.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user by an output device can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Several implementations for asset management have been described, and a number of others have been mentioned or suggested. Furthermore, those skilled in the art will readily recognize that a variety of modifications, substitutions, deletions, and/or additions may be made to these implementations while still achieving asset management. The scope of the protected subject matter therefore is to be determined on the basis of the following claims, which may encompass one or more aspects of one or more of the implementations.

In addition, it is will be understood that the terminology used herein is for the purpose of describing particular implementations and is not intended to be limiting. As used in this specification, the singular forms “a”, “an” and “the” include plural referents unless the content clearly indicates otherwise. Thus, for example, reference to “an inventory tag” includes a combination of two or more inventory tags. Accordingly, other implementations are within the scope of the following claims.

What is claimed is:

1. An asset management analysis system comprising:
a data storage module comprising data segments associated with testing one or more positions of at least one inventory tag on one or more objects, wherein at least one data segment comprises:
a first data portion comprising an object identity;
a second data portion comprising data regarding one of the inventory tags; and
at least a third data portion for test result data from testing the inventory tag;
a data storage management module operable to retrieve at least one of the data segments based on user-specified criteria; and
a data presentation module operable to format at least a portion of the retrieved data segment into a user-presentable format.

2. The system of claim 1 wherein at least two of the data segments are associated with testing two or more positions of an inventory tag on an object.

3. The system of claim 1 wherein at least two of the data segments are associated with testing one or more positions of at least two inventory tags on an object.

4. The system of claim 1 wherein a plurality of the data segments are associated with testing one or more positions of an inventory tag on each of a plurality of objects.

5. The system of claim 1 wherein the data presentation module is operable to format one or more of the retrieved data segments for visual display.

6. The system of claim 1 wherein at least one of the data segments further comprises a fourth data portion comprising descriptions of tests for testing an inventory tag.

7. The system of claim 1 wherein the third data portion comprises test result data from testing inventory tags.

8. The system of claim 1 wherein the data storage management module comprises search criteria and is capable of retrieving at least one of the data segments based on the analysis criteria.

9. The system of claim 1 wherein at least one of the data segments further comprises a fourth data portion for one or more images of an inventory tag at a position on an object.

10. The system of claim 1 further comprising a field instrument configured to be communicably coupled to the data storage module, wherein the field instrument comprises:
a communication interface configured to allow communication with the data storage module to retrieve at least one of the data segments from the data storage module;
a display configured to visually present at least a portion of at least one of the retrieved data segments; and
an input device configured to allow entry of test result data into the third data portion; and
wherein the communication interface is configured to transmit at least the data entered into the third data portions to the data storage module.

11. The system of claim 10 wherein the field instrument comprises a personal digital assistant.

12. The system of claim 10 wherein the field instrument is coupled to an inventory tag reader.

13. A method for asset management implemented on a computer, the method comprising:
storing a data storage module comprising data segments associated with testing one or more positions of at least one inventory tag on one or more objects, wherein at least one of the data segments comprises:
a first data portion comprising an object identity;
a second data portion comprising data regarding one of the inventory tags; and
a third data portion for test result data from testing the inventory tag; and
retrieving at least a portion of the data storage module.

14. The method of claim 13, wherein retrieving at least a portion of the data storage module includes retrieving at least one of the third data portions from the data storage module.

15. The method of claim 13, further comprising retrieving at least a portion of the data storage module based on one or more user-specified criteria.

16. The method of claim 13, further comprising allowing identification of at least one of: an appropriate type of inventory tag, an appropriate type of coupling between an inventory tag and at least one of the objects, or an appropriate position for at least one of the inventory tags on at least one of the objects at least partially based on the retrieved portion of the data storage module.

17. The method of claim 16 further comprising generating a report comprising deployment instructions for at least one of the inventory tags based at least partially on the identified appropriate position.

18. The method of claim 13 further comprising generating a report.

19. The method of claim 13 further comprising visually displaying the retrieved portion of the data storage module.

20. The method of claim 13 wherein at least one of the third data portions includes test result data and further comprising sorting test result data.

21. The method of claim 13 further comprising:
transmitting at least a portion of the retrieved portion of the data storage module to a field instrument;
receiving test result data from the field instrument; and
storing the received test result data in at least one of the third data portions of one or more of the data segments.

22. An article comprising a machine-readable medium storing instructions for asset management, the instructions operable to cause data processing apparatus to perform operations comprising:
storing a data storage module comprising data segments associated with testing one or more positions of at least one inventory tag on one or more objects, wherein at least one of the data segments comprises:
a first data portion comprising an object identity;
a second data portion comprising data regarding one of the inventory tags; and
a third data portion for test result data from testing the inventory tag; and
retrieving at least a portion of the data storage module.
